(19) United States
(12) Patent Application Publication
(10) Pub. No.: US 2011/0311604 A1
(43) Pub. Date: Dec. 22, 2011

(54) DOMESTIC APPLIANCE COMPRISING AN ANTIMICROBIAL AGENT

(75) Inventors: Lingge Xu, Singapore (SG); Maarten Van Den Boogaard, Westerbroek (NL); Ya Ling Lee, Singapore (SG)

(73) Assignee: KONINKLIJKE PHILIPS ELECTRONICS N.V., Eindhoven (NL)

(21) Appl. No.: 13/254,179

(22) PCT Filed: Mar. 10, 2010
(86) PCT No.: PCT/IB2010/051023

§ 371 Date: Sep. 1, 2011

(30) Foreign Application Priority Data
Mar. 12, 2009 (EP) 09155035.0

(51) Int. Cl. A01N 25/34; D06F 75/38; A01N 59/02; A01P 1/00; A01N 59/16; A01N 59/20

(52) U.S. Cl. 424/411; 424/618; 424/641; 424/630; 424/649; 424/702; 38/93

(57) ABSTRACT

The invention relates to a domestic appliance, such as an iron, provided with a surface layer. The surface layer comprises an antimicrobial agent associated with a carrier, the carrier being inorganic and selected such that the antimicrobial activity of the surface layer according to JIS Z2801:2000 has a value of at least 2 after 100 hours of continuous use at a temperature of at least 230° C. In a preferred embodiment, the carrier is selected from the group consisting of a phosphate and a soluble silicate, while the antimicrobial agent is preferably selected from a group comprising ions of silver, zinc, copper, selenium, platinum or a combination thereof. The appliance stays fresher for a longer period of time than known hitherto. The invention further relates to an iron, a steam ironing device and a method of manufacturing the appliance.

### FIELD OF THE INVENTION

The invention relates to a domestic appliance, provided with a surface layer comprising an antimicrobial agent. The invention in particular relates to an iron, a soleplate, a steam ironing device, and a method of manufacturing an iron and a method of manufacturing a soleplate.

### BACKGROUND OF THE INVENTION

Domestic appliances such as grills, (rice) cookers, pots and (frying) pans, hair rollers, hair straighteners, irons and the like increasingly have to meet higher hygienic demands. For this reason, domestic appliances are provided with antimicrobial properties. For instance, an iron provided with antimicrobial properties is known from WO 2008/044166A1. WO 2008/044166A1 discloses an iron comprising a soleplate having means for accommodating an antimicrobial agent. The soleplate contacts a garment during ironing through its garment-contact surface. The garment-contact surface of the iron of WO 2008/044166A1 is arranged for transferring the antimicrobial agent to a piece of garment during ironing thereof. By contacting the garment-contact surface with the piece of garment, as is being done during ironing, the antibacterial agent is automatically transferred to the garment. This prevents having to provide antimicrobial agent by separate means, such as by adding it to a water feed tank of the iron.

Although the anti-microbial soleplate of WO 2008/044166A1 is quite satisfactory, its functioning is based on the easy transfer of antimicrobial agent to a garment. When appliances such as an iron are not in use or being stored after use however, growth of microbes on the surface of the appliances may happen, which can lead to foul or unpleasant odours and formation of bio-films. In some cases, the attached microbes may even degrade or corrode the surface material. Since the known iron transfers antimicrobial agent onto garments, the soleplate surface thereof may lose its antimicrobial protection in time.

### SUMMARY OF THE INVENTION

It is an object of the present invention to provide an appliance, such as an iron, that is capable of retaining its antimicrobial activity for a prolonged usage period, in particular for a period extending 100 hours of use at elevated temperature and/or humidity, as is typically encountered in steam irons, pots and pans, and other domestic appliances.

This and other objects are achieved by an appliance according to claim 1. An appliance according to the invention is provided with a surface layer comprising an antimicrobial agent associated with a carrier, wherein the carrier is inorganic and selected such that the antimicrobial activity of the surface layer according to JIS Z2801:2000 has a value of at least 2 after 100 hours of continuous use at a temperature of at least 230° C. The inventors have found out that by providing a surface layer comprising an antimicrobial agent associated with an inorganic carrier, certain carriers in particular provide the desired combination of a minimal release of the antimicrobial agent for a prolonged usage period at elevated temperature. Providing antimicrobial activity for at least 100 hours in continuous use at temperatures in the range of 210 to 230° C. and higher, and in moist and abrasive conditions, is unprecedented in the art. The temperature at which the antimicrobial activity of the surface layer is measured is stipulated in the JIS Z2801:2000 norm, and is generally room temperature.

A preferred embodiment of the appliance according to the invention comprises a carrier, selected such that the antimicrobial activity of the surface layer according to JIS Z2801:2000 has a value of at least 2 after 100 hours of continuous use at a temperature of at least 240° C., more preferred at least 250° C., and most preferred at least 260° C.

In another preferred embodiment of the appliance according to the invention, the carrier is selected such that the antimicrobial activity of the surface layer according to JIS Z2801:2000 has a value of at least 3 after 100 hours of continuous use at a temperature of at least 230° C., more preferably a value of at least 4, even more preferably a value of at least 5, and most preferably a value of at least 6.

Preferably, to produce antimicrobial coating layers which are able to withstand at least 100 hours in continuous use at temperatures exceeding 230° C. and preferably are also non-yellowing, whereby the coordinate b* of CIELAB color space is smaller than 3.5, the coating is cured at a temperature ranging from about 250° C. to about 450° C.

The antimicrobial agent has antimicrobial properties, which means that it kills, or slows the growth of, microbes like bacteria (antibacterial activity) and/or fungi (antifungal activity for instance against fungi known as mold).

The appliance according to the invention preferably comprises an iron or a soleplate thereof. After ironing using an iron according to the invention, the ironed surface of the piece of garment may be provided with a small quantity of the antimicrobial agent. By ironing a piece of garment with the iron according to the invention the resistance against bacteria, fungi and the like may be enhanced. According to the invention, sufficient antibacterial agent remains in the surface layer of the appliance during use, thereby offering antibacterial protection to the appliance for a prolonged usage period.

The soleplate of an iron is usually heated by an electric heating element. The temperature of the soleplate is usually kept at a desired value by means of a thermostat and a temperature dial. The number of dots on the temperature dial indicates the temperature of the soleplate's surface, which typically corresponds to, for a 1 dot setting (the Low setting on most irons) on average 110° C., for a 2 dot setting (the Medium setting on most irons) on average 150° C., and for a 3 dot setting (the High setting on most irons) on average 200° C.

The appliance, and in particular the iron according to the invention may be used at any point in the temperature range provided by the appliance, whereby the temperature of the surface of the appliance may occasionally be as high as 260° C., and even more. Especially for an iron, the soleplate thereof is moreover subject to high abrasive forces during ironing. Indeed, the fibers of a garment tend to abrade the surface of a soleplate, in particular at the typical temperatures and moisture levels encountered when ironing.

A preferred embodiment of the appliance according to the invention comprises a carrier selected such that the antimicrobial agent does not show visible degradation after exposure to a temperature of at least 230° C. for at least 100 hours, more preferred at least 240° C., even more preferred at least 250° C. and most preferred at least 260° C.

Preferably the appliance according to the invention is characterized in that the antimicrobial agent is selected from the group of antimicrobial metal ions, and even more preferred from the group comprising ions of silver, zinc, copper, selenium, platinum or a combination thereof. Antimicrobial metal ions are metal ions having antimicrobial properties and when accommodated in the iron known from WO 2008/044166A1 show no degradation after exposure to a temperature of 250° C. for at least 4 hours. An additional advantage of the present invention is that the purposive selection of carriers provides an increased temperature stability to the antimicrobial agent, and the metal ions in particular, beyond what was known hitherto. The absence of appreciable degradation can easily be observed by visual inspection in that yellowing of the surface layer does not occur to any appreciable extent within the indicated time frame and temperature of exposure.

During storage of the iron, bacteria start to grow. An iron according to the invention, stays fresher for a longer period of time than known hitherto. The ironing soleplate itself tends to be cleaner and show a reduced growth of bacteria/fungi on its surface for a longer period of time than known hitherto.

In order to further improve the long lasting antimicrobial activity of an appliance according to the invention, the appliance may be made from a material, preferably aluminum, aluminum alloy or stainless steel, comprising metal ions of silver, copper, zinc, platinum or selenium or a combination thereof. In a practical embodiment, metal particles such as silver, copper or zinc particles or a combination thereof are incorporated in the appliance material itself. When these metal particles are exposed to oxygen, as is present in the air, conversion of metal to metal oxide occurs spontaneously at the surface of these particles, resulting in the presence of antimicrobial metal ions (in this case silver, copper or zinc ions or a combination thereof) in the appliance.

Conversion of Ag to Ag₂O occurs spontaneously when Ag is exposed to oxygen present in the air. This conversion occurs slowly. Increasing the temperature increases the speed at which the conversion of the metal to the metal oxide occurs. The typical ironing temperatures are thus very suitable for generating an Ag to Ag₂O conversion and hence for generating Ag+ ions. However, this may also result in degradation and yellowing of the appliance material. The purposively selected carriers according to the invention at least retard such degradation.

It has turned out that an appliance according to a preferred embodiment comprises a carrier selected from the group consisting of a phosphate and a soluble silicate. These carriers in particular have shown to yield the desired combination of slow and/or very limited release of antimicrobial agent and prolonged appliance protection. The preferred carrier associated with the antimicrobial agent, and a silver ion in particular, is one which protects the antimicrobial agent from discoloration when exposed to heat, humidity and/or light. In one particular preferred embodiment, the antimicrobial agent carrier is a zirconium phosphate, such as but not limited to Alphasan® RC 2000 (Milliken and Co., Spartanburg, S.C.). In another preferred embodiment, the antimicrobial agent carrier is a soluble silicate, preferably one that is soluble in water, such as, but not limited to, IonPure® IZA<40 μm, and more preferably IonPure® IZA<10 μm (Ishizuka Glass Co., Naguya, Japan). The soluble silicate may be a glass powder, such as sodium silicate, but may also be another form of silicate such as, but not limited to, a potassium silicate. In some embodiments, the soluble silicate is soluble in an aqueous environment. The antimicrobial agent may be associated with the carrier by one or more of many well-known physical and chemical means. In some embodiments, the association of the silver with the carrier is by ionic bonds, covalent bonds, and/or physical sequestration. The inventors have also found that carriers such as a zeolite do not have the desired structure and therefore do not yield the desired results. A zeolite carrier therefore is not preferred, and is preferably excluded from the group of suitable carriers.

It has also turned out that the amount of antimicrobial agent in the surface layer of the appliance according to the invention is not particularly critical. However, a particularly preferred embodiment has a surface layer comprising a phosphate and at least 0.05 vol.-% of antimicrobial agent, more preferred at least 0.10 vol.-%, and most preferred at least 0.15 vol.-% of antimicrobial agent.

In another particularly preferred embodiment, the appliance according to the invention has a surface layer comprising a soluble silicate and at most 0.10 vol.-% of antimicrobial agent, more preferably at most 0.05 vol.-%, and most preferably at most 0.02 vol.-% of antimicrobial agent. The antimicrobial agent may be present as particles, the particles preferably having an average size in the range of 1 nm-100 μm, more preferably in the range of 1-30 μm, and most preferably in the range of 5-15 μm.

According to the invention, the appliance comprises a surface layer having an antimicrobial agent. In an embodiment, the appliance is provided with the surface layer comprising the antimicrobial agent. Layers having a thickness in a range of 0.5-250 μm have been found suitable.

Alternatively, the layer comprises a thermoplastic polymer, a sol-gel or an enamel material comprising the antimicrobial agent, a sol-gel material being the preferred material.

Suitable thermoplastic polymers are thermally stable polymers such as silicones, polyimides, polyamide imide, polyether amide, polyether sulfone, polyether ether ketone, polyphenyl sulfide polysulfone and polytetra fluoro ethylene. The layer may be a sol-gel coating comprising the antimicrobial agent and having a thickness in the range of 5-100 μm.

The invention also relates to a steam ironing device. The steam ironing device according to the invention comprises a steam-generating means and an iron according to the invention, i.e. provided with a surface layer comprising an antimicrobial agent associated with a carrier, wherein the carrier is inorganic and selected such that the antimicrobial activity of the surface layer according to JIS Z2801:2000 has a value of at least 2 after 100 hours of continuous use at a temperature of at least 230° C., wherein the soleplate comprises at least one opening and the steam-generating means is arranged for delivering steam to the opening.

In a conventional steam iron, steam is generated by a steam generating means, which comprises a water reservoir and a steam chamber. Usually, a water-dosing pump is provided to pump the water from the water reservoir to the steam chamber (as drops rather than a large flow of water). The water may be pumped via a hose under command of a pump signal from an electric control device. The rate at which water is supplied dictates the amount of steam being produced, and the amount of steam is sufficiently small that the temperature of the sole plate is not significantly affected. Instead of a pumped system, water can be dosed to the steam chamber under gravity.

The steam chamber is typically heated by the sole plate, but an auxiliary heating element may instead be provided. The steam from the steam chamber reaches a steam outlet opening or openings provided in the sole plate of the iron. While being ironed using the steam function on the iron, the garment surface is moistened by the steam and contacted by the garment-contact surface comprising the antimicrobial agent of the iron at the same time.

The steam ironing device as such is well-known in practice. The steam ironing device may be a steam iron or a so-called boiler ironing system. The boiler ironing system comprises a steam iron having a soleplate with a soleplate surface and a boiler for heating water which is arranged separately from the steam iron, wherein the water tank is attached to a stand comprising the boiler. In many cases, the water tank is removably arranged, so that a user of the device comprising the water tank is capable of taking the water tank to a tap or the like in order to fill the water tank, without having to move the entire device.

In an embodiment of the steam ironing device according to the invention, the steam generating means comprises a steam chamber.

In another embodiment of the steam ironing device according to the invention, the steam generating means comprises a boiler. The steam generating means may be housed by an ironing board.

The invention also relates to a method of manufacturing an appliance according to the invention. The invented method comprising preparing a layer material containing a suitable amount of antimicrobial agent and carrier associated therewith, the carrier being selected such that the antimicrobial activity of the surface layer according to JIS Z2801:2000 has a value of at least 2 after 100 hours in continuous use at a temperature of at least 230° C., more preferably at least 240° C., even more preferably at least 250° C., and most preferably at least 260° C., and providing the layer material onto a surface of the appliance. In another preferred method the carrier is selected such that the antimicrobial activity of the surface layer according to JIS Z2801:2000 has a value of at least 3 after 100 hours of continuous use at a temperature of at least 230° C., more preferably a value of at least 4, even more preferably a value of at least 5, and most preferably a value of at least 6.

A way to execute one of the methods according to the invention as described above is to apply a polymer layer comprising the antimicrobial agent to the soleplate. More preferred is to apply a sol-gel coating and/or enamel coating comprising the antimicrobial agent to the soleplate and cure the soleplate thus obtained. Both coatings in particular are wear resistant and provide a long-lasting antimicrobial effect. Applying a sol-gel coating as such is known per se, but for the manufacture of an appliance according to the invention, and a soleplate in particular, a very suitable method comprises the steps of providing a sol-gel solution, spraying the sol-gel solution onto the surface of the appliance, drying the sol-gel layer thus obtained, for instance by heating the appliance at least partially, such that solvent for instance is evaporated and a gel network results, and finally curing the gel by additional heating. Drying and subsequent curing may be combined in one curing step. The antimicrobial agent is generally admixed to the sol-gel solution before applying it to the surface of the appliance.

Although it is possible to apply a sol-gel solution to the surface of the appliance and on top of that apply antimicrobial agent e.g. by spraying a solution comprising the antimicrobial agent, this method is not preferred, since the long-lasting effect may not occur to the desired extent.

The invention also includes any possible combination of features or subject matter as claimed in any one of the claims.

### BRIEF DESCRIPTION OF THE DRAWINGS

The invention will now be described, by way of example, with reference to the accompanying drawings. In principle, aspects can be combined.

FIG. 1 schematically depicts an embodiment of an iron according to the invention.

FIG. 2 schematically depicts an embodiment of a steam ironing device according to the invention.

FIG. 3 schematically depicts another embodiment of the steam ironing device according to the invention.

### DETAILED DESCRIPTION OF THE EMBODIMENTS

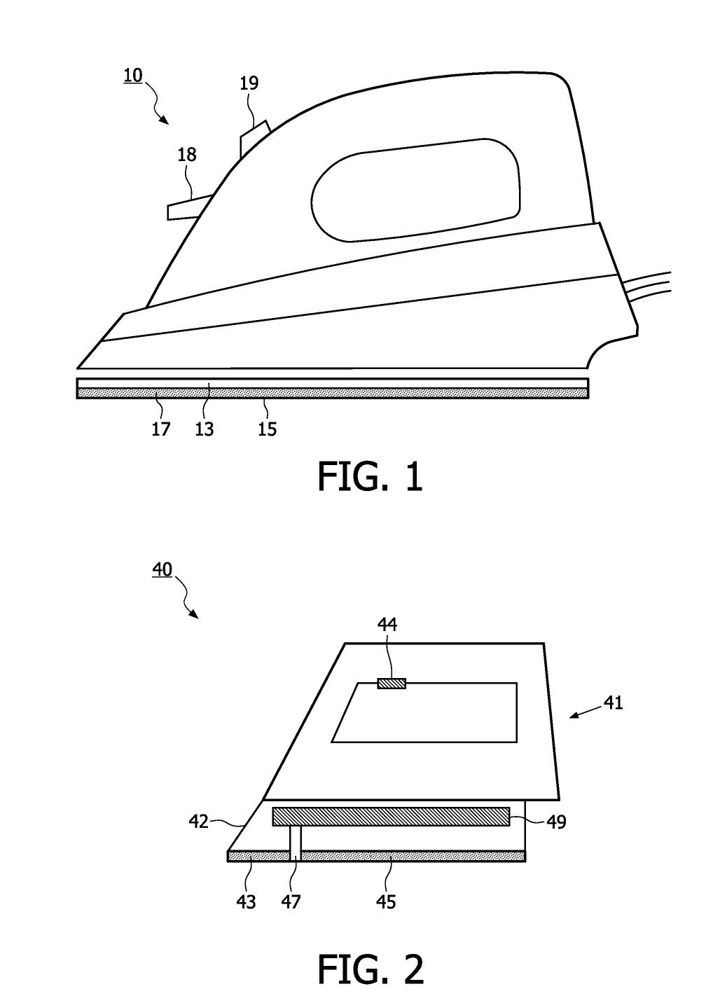

In FIG. 1 a preferred embodiment of the iron according to the invention is schematically depicted. The iron 10 comprises a soleplate 13 provided with an antimicrobial layer 17 comprising an antimicrobial agent. The layer 17 has a garment-contact surface 15. The iron further comprises a means for supplying water to the fabric to be ironed. This water-supply means comprises a depressable water trigger 19 and a water sprayer 18 connected to a water reservoir (not shown).

In FIG. 2 an embodiment of the steam ironing device according to the invention is schematically depicted. This device is provided with a steam iron 40 comprising a soleplate 42 provided with a layer 43 comprising an antimicrobial agent and having the steam outlet opening 47. The layer 43 comprises the garment-contact surface 45. The steam iron 40 further comprises a means for generating steam. The steam generating means comprises a steam chamber 49 and a water reservoir (not shown). The steam-generating means is arranged for providing steam via the opening 47 to the piece of garment to be ironed. A water sprayer (not shown) may be provided to moisten the garment.

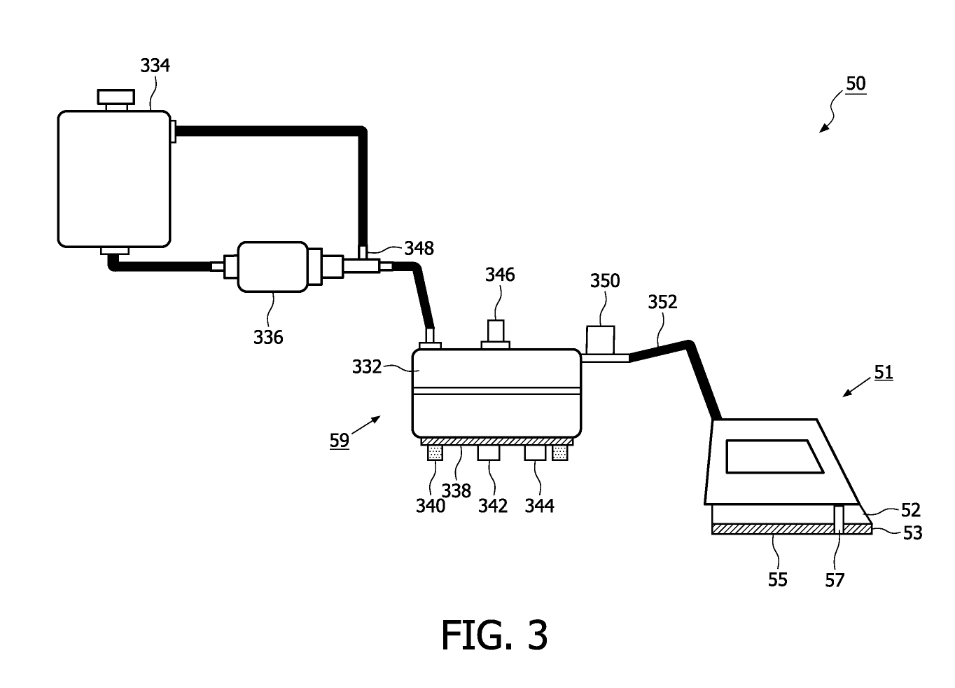

In FIG. 3 another embodiment of the steam ironing device according to the invention is depicted. The steam ironing device 50 in this embodiment is the so-called boiler ironing system. In such a system a steam-generating means 59 comprises a boiler 332 for heating water, which is arranged separately from a steam iron 51 according to the invention, and a water tank 334. The boiler 332 comprises a heating plate 338 connected to a heating element 340. An electro valve 350 is arranged that opens to let steam pass via a steam delivery hose 352 to the iron 51. The boiler usually further comprises a pressure sensor 342 to measure the pressure inside the boiler, a water-level sensor 344 and a safety valve 346 that opens if the pressure inside the boiler 332 is too high, i.e. above a certain set value. To fill the boiler, water is pumped by a water pump 336 from the water tank 334 to the boiler 332. A de-airing valve 348 may be present to let air out of the water.

The steam ironing device 50 comprises the iron 51 according to the invention having a soleplate 52. An antimicrobial layer 53 according to the invention is provided onto the sole plate 52 of the iron 51. The antimicrobial layer 53 comprises a garment-contact surface 55. The sole plate 52 of the iron comprises a steam-outlet opening 57.

To illustrate the effect of the purposively selected carrier/antimicrobial agent combination, the following examples are given hereinafter.

### Example 1

In a reaction vessel 5.5 g of maleic acid was dissolved in 380 g of LudoxAS40, a colloidal silica 40 wt. % suspension in water. An amount of 0.95 g of methyltrimethoxysilane (MTMS) was then added and the mixture was stirred for 45 minutes. Subsequently, 391 g of MTMS was stirred into the acidified silica sol. Sixty minutes later the mixture was diluted with 196 g of water before the gradual addition of 315 g of 30% polytetrafluoroethylene (PTFE) dispersion in water stabilized with a polysiloxane polyoxyalkylene copolymer (SIL WET L77) together with a suitable defoaming agent. After the addition of the PTFE had been completed, 30 g of a mica-based pigment was added followed by 12 g of Ionpure IZA (particle size <10 μm), a soluble phosphate glass.

Coatings were sprayed on previously dried sol-gel layers applied on anodized aluminium plates and cured at 300° C. The amount of Ionpure IZA particles in the cured coating was approximately 1.7% by volume (the amount of Ag being approximately 0.01% by volume).

### Example 2

In a reaction vessel 5.5 g of maleic acid was dissolved in 380 g of LudoxAS40. An amount of 0.95 g of MTMS was then added and the mixture was stirred for 45 minutes. Subsequently 391 g of MTMS was stirred into the acidified silica sol. 60 minutes later the mixture was diluted with 196 g of water before the gradual addition of 315 g of 30% PTFE dispersion in water stabilized with SIL WET L77 together with a suitable defoaming agent. After the addition of the PTFE had been completed, 30 g of a mica-based pigment was added followed by 46 g of AlphaSan RC2000, a zirconium phosphate.

Coatings were sprayed on previously dried sol-gel layers applied on anodized aluminum plates and cured at 300° C. The amount of AlphaSan RC2000 particles in the cured coating was approximately 6.0% by volume (the amount of Ag was approximately 0.17% by volume).

### Comparative Experiment A

In a reaction vessel 5.5 g of maleic acid was dissolved in 380 g of LudoxAS40. An amount of 0.95 g of MTMS was then added and the mixture was stirred for 45 minutes. Subsequently 391 g of MTMS was stirred into the acidified silica sol. 60 minutes later the mixture was diluted with 196 g of water before the gradual addition of 315 g of 30% PTFE dispersion in water stabilized with SIL WET L77 together with a suitable defoaming agent. After the addition of the PTFE had been completed, 30 g of a mica-based pigment was added followed by 11.8 g of AlphaSan RC2000, a zirconium phosphate.

Coatings were sprayed on previously dried sol-gel layers applied on anodized aluminum plates and cured at 300° C. The amount of AlphaSan RC2000 particles in the cured coating was approximately 1.5% by volume (the amount of Ag was approximately 0.04% by volume).

### Comparative Experiment B

In a reaction vessel 5.5 g of maleic acid was dissolved in 380 g of LudoxAS40. An amount of 0.95 g of MTMS was then added and the mixture was stirred for 45 minutes. Subsequently 391 g of MTMS was stirred into the acidified silica sol. 60 minutes later the mixture was diluted with 196 g of water before the gradual addition of 315 g of 30% PTFE dispersion in water stabilized with SIL WET L77 together with a suitable defoaming agent. After the addition of the PTFE had been completed, 30 g of a mica-based pigment was added followed by 3.0 g of AlphaSan RC2000, a zirconium phosphate.

Coatings were sprayed on previously dried sol-gel layers applied on anodized aluminum plates and cured at 300° C. The amount of AlphaSan RC2000 particles in the cured coating was approximately 0.37% by volume (the amount of Ag was approximately 0.01% by volume).

### Comparative Experiment C

In a reaction vessel 5.5 g of maleic acid was dissolved in 380 g of LudoxAS40. An amount of 0.95 g of MTMS was then added and the mixture was stirred for 45 minutes. Subsequently 391 g of MTMS was stirred into the acidified silica sol. 60 minutes later the mixture was diluted with 196 g of water before the gradual addition of 315 g of 30% PTFE dispersion in water stabilized with SIL WET L77 together with a suitable defoaming agent. After the addition of the PTFE had been completed, 30 g of a mica-based pigment was added followed by 2.5 g of AgIon® (WAJ), a zeolite based slurry with 20 wt % solid containing Ag⁺. Coatings were sprayed on previously dried sol-gel layers applied on anodized aluminum plates and cured at 300° C. The amount of AgIon® particles in the cured coating was approximately 0.3% by volume.

The anti-microbial activity of the produced surface coating layers was measured by quantifying the survival of bacterial cells which have been held in intimate contact for 24 hours at 35° C. with the surface of the surface layer. The anti-microbial effect is measured by comparing the survival of bacteria on a treated material with that achieved on an untreated material. The anti-microbial tests were carried out according to Japan Industrial Standard (JIS), JIS Z 2801: 2000 “Antimicrobial products—Tests for antimicrobial activity and efficacy”.

The results obtained are summarized in Table 1 below.

TABLE 1
Anti-microbial activity of coating layers

| | Value of Anti-microbial Activity\hat{ } | |
|---|---|---|
| | (JIS Z2801: 2000) | |
| | | Coating after 100 h of continuous |
| Example/Comparative | Coating | wearing on fabric under steam |
| Experiment | at 0 h | condition and 2 kg load |
| Example 1: IonPure IZA | 5.2 | >6.0 |
| (Ag 0.01 vol %) | | |
| Example 2: Alphasan RC | 4.9 | >6.0 |
| 2000 | | |
| (Ag 0.17 vol %) | | |
| Comp. Exp. A: Alphasan | 5.3 | 0.3 |
| RC 2000 | | |
| (Ag 0.04 vol %) | | |
| Comp. Exp. B: Alphasan | 2.5 | 0.5 |
| RC 2000 | | |
| (Ag 0.01 vol %) | | |
| Comp. Exp. C: Zeolite | >6.0 | 0.3 |
| AgION ® WAJ slurry | | |
| (Ag 0.06 vol %)* | | |

*Lumps formation (incompatibility) observed, higher loading not feasible.
\hat{ }This is the log reduction of the living bacteria population on the treated sample and that on the control surface. It should be not less than 2.0 for antibacterial finish, i.e. over 99% of the micro-organisms must be killed in excess to the untreated material or article.

The release mechanisms of silver ions and its concentration in the coating influence the ability for the anti-microbial function to be wear resistant. As shown in Table 1, the preferred concentration of soluble glass additives such as IonPure IZA is low (as low as 0.01% by Ag volume in coating) to maintain its anti-microbial function for more than 100 hours of wearing. The preferred concentration however of additives that release silver ions by ion exchange, such as Alphasan RC 2000, is higher. Indeed Alphasan RC 2000 shows a relatively poor anti-microbial function after 100 hours of wearing if the amount of additive is too low (lower than 0.1% by Ag volume in coating). For such additive, a long lasting anti-microbial function is preferably achieved with a higher loading (higher than 0.1% by Ag volume in coating).

A coating according to the disclosure of WO 2008/044166A1 shows a very poor anti-microbial function after 100 hours of wearing, as is clear from the results of Comparative Experiment C. Higher loadings of AgION (WAJ) result in incompatibility with the coating.

The present invention offers a unique wear resistant inorganic coating with anti-microbial agent incorporated. This coating retains excellent anti-microbial properties for at least 100 hours of mechanical wearing, without discoloration or yellowing.

The coating has anti-microbial function on bacteria like Staphylococcus aureus and Escherichia Coli. For example, using the coating on a soleplate of a steam iron, it has excellent wear resistance and has a long lasting anti-microbial effect upon continuous use at 230° C. at least. It is crack-free with a layer thickness of 10-40 μm being preferred. The coating does not show any visible color change after 600 cycles of heating with steam and cooling process. Scratch resistance of the coatings according to the invention is excellent.

1. Domestic appliance, such as an iron, provided with a surface layer comprising an antimicrobial agent associated with a carrier, wherein the carrier is inorganic and selected such that the antimicrobial activity of the surface layer according to JIS Z2801:2000 has a value of at least 2 after 100 hours of continuous use at a temperature of at least 230° C.

2. Appliance according to claim 1, wherein the carrier is selected such that the antimicrobial activity of the surface layer according to JIS Z2801:2000 has a value of at least 2 after 100 hours of continuous use at a temperature of at least 250° C.

3. Appliance according to claim 1, wherein the carrier is selected such that the antimicrobial agent does not show visible degradation after exposure to a temperature of at least 230° C. for at least 100 hours.

4. Appliance according to claim 1, wherein the carrier is one or more selected from the group consisting of a phosphate and a soluble silicate.

5. Appliance according to claim 4, wherein the carrier is zirconium phosphate and/or a water soluble glass powder.

6. Appliance according to claim 4, wherein the antimicrobial agent is selected from a group comprising ions of silver, zinc, copper, selenium, platinum or a combination thereof.

7. Appliance according to claim 4, wherein the surface layer comprises a phosphate and at least 0.10 volume percent of the antimicrobial agent.

8. An iron according to claim 4, wherein the surface layer comprises a soluble silicate and at most 0.05 volume percent of the antimicrobial agent.

9. Appliance according to claim 4, wherein the surface layer comprises a sol-gel and/or enamel material.

10. Appliance according to claim 4, the appliance comprising an iron or a soleplate thereof.

11. A steam ironing device (30, 40, 50) comprising a steam generating means (39, 49, 59) and an iron (31, 41, 51) according to claim 10, the soleplate (3, 13, 33, 43, 52) of the iron comprising at least one steam outlet opening (37, 47, 57) and the steam generating means being arranged for delivering steam to said opening.

12. Method of manufacturing an appliance according to claim 4, the method comprising preparing a layer material containing a suitable amount of antimicrobial agent and carrier associated therewith, and providing the layer material onto a surface of the appliance.
